(19) United States
(12) Patent Application Publication
(10) Pub. No.: US 2012/0137090 A1
(43) Pub. Date: May 31, 2012

(54) Programmable Interleave Select in Memory Controller

(76) Inventors: Sukalpa Biswas, Fremont, CA (US); Hao Chen, (US)

(21) Appl. No.: 12/955,714

(22) Filed: Nov. 29, 2010

(51) Int. Cl. G06F 12/00

(52) U.S. Cl. 711/157; 711/E12.001

(57) ABSTRACT

In one embodiment, a memory controller may be configured to perform a logic operation, such as a hash function, on selected address bits to produce a bit of channel or bank select. The selected address bits for each select bit may differ, and may be programmable in some embodiments. By combining selected address bits to produce the select bits, the distribution of addresses in a set of regular access patterns may be somewhat randomized to the channels/banks. In one implementation, each select bit may have a corresponding programmable bit vector that specifies the address bits to be included for that select bit. Accordingly, any subset of the address bits may be included in any select bit generation.

### BACKGROUND

1. Field of the Invention

This invention is related to the field of memory controllers.

2. Description of the Related Art

Digital systems generally include a memory system formed from semiconductor memory devices such as static random access memory (SRAM), dynamic random access memory (DRAM), synchronous DRAM (SDRAM), double data rate (DDR, DDR2, DDR3, etc.) SDRAM including low power versions (LPDDR, LPDDR2, etc.) SDRAM, etc. The memory system is volatile, retaining data when powered on but not when powered off, but also provides low latency access as compared to nonvolatile memories such as Flash memory, magnetic storage devices such as disk drives, or optical storage devices such a compact disk (CD), digital video disk (DVD), and BluRay drives.

The memory devices forming the memory system have a low level interface to read and write the memory according to memory device-specific protocols. The sources that generate memory operations typically communicate via a higher level interface such as a bus, a point-to-point packet interface, etc. The sources can be processors, peripheral devices such as input/output (I/O) devices, audio and video devices, etc. Generally, the memory operations include read memory operations to transfer data from the memory to the device and write memory operations to transfer data from the source to the memory. Read memory operations may be more succinctly referred to herein as read operations or reads, and similarly write operations may be more succinctly referred to herein as write operations or writes.

Accordingly, a memory controller is typically included to receive the memory operations from the higher level interface and to control the memory devices to perform the received operations. The memory controller generally also includes queues to capture the memory operations, and can include circuitry to improve performance. For example, some memory controllers schedule read memory operations ahead of earlier write memory operations that affect different addresses.

Typically, the memory controller includes two or more channels to access independent sets of memory devices, and two or more banks of memory on each channel. The memory controller interleaves the memory address space over the channels and banks in an attempt to maximize the memory bandwidth. Generally, a field of consecutive address bits is used to identify a channel/bank. For example, one address bit is used to distinguish between two channels or banks, two address bits are used to distinguish between four channels or banks, etc. For any given interleave, there are access patterns and/or data access sizes that are problematic for the interleave (e.g. mapping to the same channel or bank repeatedly), reducing the bandwidth that can be achieved from the memory.

### SUMMARY

In one embodiment, a memory controller may be configured to perform a logic operation, such as a hash function, on selected address bits to produce a bit of channel or bank select. The selected address bits for each channel/bank select bit may differ, and may be programmable in some embodiments. By combining address bits to produce the select bits, the distribution of addresses in a set of regular access patterns may be somewhat randomized to the channels/banks, which may improve the distribution of operations to the channels/banks in some cases.

In one implementation, each select bit may have a corresponding programmable bit vector that specifies the address bits to be included for that select bit. Accordingly, any subset of the address bits may be included in any select bit generation. The programmability of the address bits may permit software to balance address mappings to the channels/banks to expected data structure sizes, workloads, etc.

### BRIEF DESCRIPTION OF THE DRAWINGS

The following detailed description makes reference to the accompanying drawings, which are now briefly described.

FIG. 1 is a block diagram of one embodiment of a system including a memory controller.

FIG. 2 is a block diagram of one embodiment of the memory controller shown in FIG. 1.

FIG. 3 is a block diagram of one embodiment of a port interface unit that may be included in one embodiment of an agent interface unit shown in FIG. 2.

FIG. 4 is a block diagram of one embodiment channel select circuits and bank select circuits shown in FIG. 3.

FIG. 5 is a flowchart illustrating operation of one embodiment of read/write spawn generation circuits.

FIG. 6 is a block diagram of one embodiment of a system including an integrated circuit illustrated in FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

### Overview

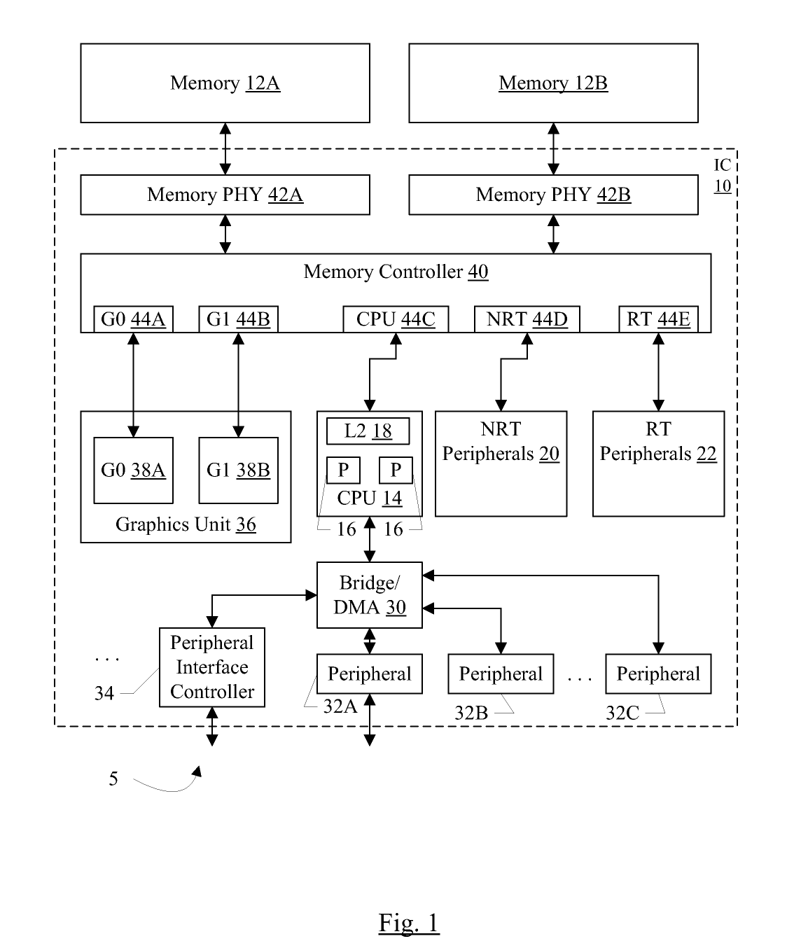

Turning now to FIG. 1, a block diagram of one embodiment of a system 5 is shown. In the embodiment of FIG. 1, the system 5 includes an integrated circuit (IC) 10 coupled to external memories 12A-12B. In the illustrated embodiment, the integrated circuit 10 includes a central processor unit (CPU) block 14 which includes one or more processors 16 and a level 2 (L2) cache 18. Other embodiments may not include L2 cache 18 and/or may include additional levels of cache. Additionally, embodiments that include more than two processors 16 and that include only one processor 16 are contemplated. The integrated circuit 10 further includes a set of one or more non-real time (NRT) peripherals 20 and a set of one or more real time (RT) peripherals 22. In the illustrated embodiment, the CPU block 14 is coupled to a bridge/direct memory access (DMA) controller 30, which may be coupled to one or more peripheral devices 32A-32C and/or one or more peripheral interface controllers 34. The number of peripheral devices 32 and peripheral interface controllers 34 may vary from zero to any desired number in various embodiments. The system 5 illustrated in FIG. 1 further includes a graphics unit 36 comprising one or more graphics controllers such as G0 38A and G1 38B. The number of graphics controllers per graphics unit and the number of graphics units may vary in other embodiments. As illustrated in FIG. 1, the system 5 includes a memory controller 40 coupled to one or more memory physical interface circuits (PHYs) 42A-42B. The memory PHYs 42A-42B are configured to communicate on pins of the integrated circuit 10 to the memories 12A-12B. The memory controller 40 also includes a set of ports 44A-44E. The ports 44A-44B are coupled to the graphics controllers 38A-38B, respectively. The CPU block 14 is coupled to the port 44C. The NRT peripherals 20 and the RT peripherals 22 are coupled to the ports 44D-44E, respectively. The number of ports included in a memory controller 40 may be varied in other embodiments, as may the number of memory controllers. That is, there may be more or fewer ports than those shown in FIG. 1. The number of memory PHYs 42A-42B and corresponding memories 12A-12B may be one or more than two in other embodiments.

Generally, a port may be a communication point on the memory controller 40 to communicate with one or more sources. In some cases, the port may be dedicated to a source (e.g. the ports 44A-44B may be dedicated to the graphics controllers 38A-38B, respectively). In other cases, the port may be shared among multiple sources (e.g. the processors 16 may share the CPU port 44C, the NRT peripherals 20 may share the NRT port 44D, and the RT peripherals 22 may share the RT port 44E). Each port 44A-44E is coupled to an interface to communicate with its respective agent. The interface may be any type of communication medium (e.g. a bus, a point-to-point interconnect, etc.) and may implement any protocol. The interconnect between the memory controller and sources may also include any other desired interconnect such as meshes, network on a chip fabrics, shared buses, point-to-point interconnects, etc.

In one embodiment, each port 44A-44E may be associated with a particular type of traffic. For example, in one embodiment, the traffic types may include RT traffic, NRT traffic, and graphics traffic. Other embodiments may include other traffic types in addition to, instead of, or in addition to a subset of the above traffic types. Each type of traffic may be characterized differently (e.g. in terms of requirements and behavior), and the memory controller may handle the traffic types differently to provide higher performance based on the characteristics. For example, RT traffic requires servicing of each memory operation within a specific amount of time. If the latency of the operation exceeds the specific amount of time, erroneous operation may occur in the RT peripheral. For example, image data may be lost or a displayed image may visually distort. RT traffic may be characterized as isochronous, for example. On the other hand, graphics traffic may be relatively high bandwidth, but is not latency-sensitive. NRT traffic, such as from the processors 16, is more latency-sensitive for performance reasons but survives higher latency. That is, NRT traffic may generally be serviced at any latency without causing erroneous operation in the devices generating the NRT traffic. Similarly, the less latency-sensitive but higher bandwidth graphics traffic may be generally serviced at any latency. Other NRT traffic may include audio traffic, which is relatively low bandwidth and generally may be serviced with reasonable latency. Most peripheral traffic may also be NRT (e.g. traffic to storage devices such as magnetic, optical, or solid state storage). By providing ports 44A-44E associated with different traffic types, the memory controller 40 may be exposed to the different traffic types in parallel, and may thus be capable of making better decisions about which memory operations to service prior to others based on traffic type.

Each port 44A-44E is coupled to an interface to communicate with its respective agent. The interface may be any type of communication medium (e.g. a bus, a point-to-point interconnect, etc.) and may implement any protocol. In some embodiments, the ports 44A-44E may all implement the same interface and protocol. In other embodiments, different ports may implement different interfaces and/or protocols. An interface may refer to the signal definitions and electrical properties of the interface, and the protocol may be the logical definition of communications on the interface (e.g. including commands, ordering rules, coherence support if any, etc.).

In an embodiment, each source may assign a quality of service (QoS) parameter to each memory operation transmitted by that source. The QoS parameter may identify a requested level of service for the memory operation. Memory operations with QoS parameter values requesting higher levels of service may be given preference over memory operations requesting lower levels of service. Specifically, in an example, each memory operation may include a command, a flow identifier (FID), and a QoS parameter (QoS). The command may identify the memory operation (e.g. read or write). A read command/memory operation causes a transfer of data from the memory 12A-12B to the source, whereas a write command/memory operation causes a transfer of data from the source to the memory 12A-12B. Commands may also include commands to program the memory controller 40. The FID may identify a memory operation as being part of a flow of memory operations. A flow of memory operations may generally be related, whereas memory operations from different flows, even if from the same source, may not be related. A portion of the FID (e.g. a source field) may identify the source, and the remainder of the FID may identify the flow (e.g. a flow field). Thus, an FID may be similar to a transaction ID, and some sources may simply transmit a transaction ID as an FID. In such a case, the source field of the transaction ID may be the source field of the FID and the sequence number (that identifies the transaction among transactions from the same source) of the transaction ID may be the flow field of the FID. Sources that group transactions as a flow, however, may use the FIDs differently. Alternatively, flows may be correlated to the source field (e.g. operations from the same source may be part of the same flow and operations from a different source are part of a different flow). The ability to identify transactions of a flow may be used in a variety of ways described below (e.g. QoS upgrading, reordering, etc.).

Thus, a given source may be configured to use QoS parameters to identify which memory operations are more important to the source (and thus should be serviced prior to other memory operations from the same source), especially for sources that support out-of-order data transmissions with respect to the address transmissions from the source. Furthermore, the QoS parameters may permit sources to request higher levels of service than other sources on the same port and/or sources on other ports.

The memory controller 40 may be configured to process the QoS parameters received on each port 44A-44E and may use the relative QoS parameter values to schedule memory operations received on the ports with respect to other memory operations from that port and with respect to other memory operations received on other ports. More specifically, the memory controller 40 may be configured to compare QoS parameters that are drawn from different sets of QoS parameters (e.g. RT QoS parameters and NRT QoS parameters) and may be configured to make scheduling decisions based on the QoS parameters.

In some embodiments, the memory controller 40 may be configured to upgrade QoS levels for pending memory operations. Various upgrade mechanism may be supported. For example, the memory controller 40 may be configured to upgrade the QoS level for pending memory operations of a flow responsive to receiving another memory operation from the same flow that has a QoS parameter specifying a higher QoS level. This form of QoS upgrade may be referred to as in-band upgrade, since the QoS parameters transmitted using the normal memory operation transmission method also serve as an implicit upgrade request for memory operations in the same flow. The memory controller 40 may be configured to push pending memory operations from the same port or source, but not the same flow, as a newly received memory operation specifying a higher QoS level. As another example, the memory controller 40 may be configured to couple to a sideband interface from one or more agents, and may upgrade QoS levels responsive to receiving an upgrade request on the sideband interface. In another example, the memory controller 40 may be configured to track the relative age of the pending memory operations. The memory controller 40 may be configured to upgrade the QoS level of aged memory operations at certain ages. The ages at which upgrade occurs may depend on the current QoS parameter of the aged memory operation.

The memory controller 40 may be configured to determine the memory channel addressed by each memory operation received on the ports, and may be configured to transmit the memory operations to the memory 12A-12B on the corresponding channel. The number of channels and the mapping of addresses to channels may vary in various embodiments and may be programmable in the memory controller. Specifically, the memory controller 40 may implement the logical combination of address bits to generate channel and/or bank selects described above and in more detail below, in various embodiments. More specifically, the memory controller 40 may include one or more logic circuits configured to generate bank select and channel select data from the combinations of address bits. For example, an embodiment having two channels such as that shown in FIG. 1 may logically combine address bits to generate a single channel select bit (which may indicate channel 0 when clear and channel 1 when set, for example). An embodiment having four channels may logically combine a first set of address bits to generate one channel select bit and a second set of address bits to generate another channel select bit. Together, the two channel select bits may select one of the four channels. Larger numbers of channels may be similarly supported, and any number of banks may also be supported in a similar fashion.

The memory controller 40 may be configured to use the QoS parameters of the memory operations mapped to the same channel to determine an order of memory operations transmitted into the channel. That is, the memory controller 40 may reorder the memory operations from their original order of receipt on the ports. Additionally, during processing in the channel, the memory operations may be reordered again at one or more points. At each level of reordering, the amount of emphasis placed on the QoS parameters may decrease and factors that affect memory bandwidth efficiency may increase. Once the memory operations reach the end of the memory channel pipeline, the operations may have been ordered by a combination of QoS levels and memory bandwidth efficiency. High performance may be realized in some embodiments.

The processors 16 may implement any instruction set architecture, and may be configured to execute instructions defined in that instruction set architecture. The processors 16 may employ any microarchitecture, including scalar, superscalar, pipelined, superpipelined, out of order, in order, speculative, non-speculative, etc., or combinations thereof. The processors 16 may include circuitry, and optionally may implement microcoding techniques. The processors 16 may include one or more level 1 caches, and thus the cache 18 is an L2 cache. Other embodiments may include multiple levels of caches in the processors 16, and the cache 18 may be the next level down in the hierarchy. The cache 18 may employ any size and any configuration (set associative, direct mapped, etc.).

The graphics controllers 38A-38B may be any graphics processing circuitry. Generally, the graphics controllers 38A-38B may be configured to render objects to be displayed into a frame buffer. The graphics controllers 38A-38B may include graphics processors that may execute graphics software to perform a part or all of the graphics operation, and/or hardware acceleration of certain graphics operations. The amount of hardware acceleration and software implementation may vary from embodiment to embodiment.

The NRT peripherals 20 may include any non-real time peripherals that, for performance and/or bandwidth reasons, are provided independent access to the memory 12A-12B. That is, access by the NRT peripherals 20 is independent of the CPU block 14, and may proceed in parallel with CPU block memory operations. Other peripherals such as the peripherals 32A-32C and/or peripherals coupled to a peripheral interface controlled by the peripheral interface controller 34 may also be non-real time peripherals, but may not require independent access to memory. Various embodiments of the NRT peripherals 20 may include video encoders and decoders, scaler circuitry and image compression and/or decompression circuitry, etc.

The RT peripherals 22 may include any peripherals that have real time requirements for memory latency. For example, the RT peripherals may include an image processor and one or more display pipes. The display pipes may include circuitry to fetch one or more frames and to blend the frames to create a display image. The display pipes may further include one or more video pipelines. The result of the display pipes may be a stream of pixels to be displayed on the display screen. The pixel values may be transmitted to a display controller for display on the display screen. The image processor may receive camera data and process the data to an image to be stored in memory.

The bridge/DMA controller 30 may comprise circuitry to bridge the peripheral(s) 32 and the peripheral interface controller(s) 34 to the memory space. In the illustrated embodiment, the bridge/DMA controller 30 may bridge the memory operations from the peripherals/peripheral interface controllers through the CPU block 14 to the memory controller 40. The CPU block 14 may also maintain coherence between the bridged memory operations and memory operations from the processors 16/L2 Cache 18. The L2 cache 18 may also arbitrate the bridged memory operations with memory operations from the processors 16 to be transmitted on the CPU interface to the CPU port 44C. The bridge/DMA controller 30 may also provide DMA operation on behalf of the peripherals 32 and the peripheral interface controllers 34 to transfer blocks of data to and from memory. More particularly, the DMA controller may be configured to perform transfers to and from the memory 12A-12B through the memory controller 40 on behalf of the peripherals 32 and the peripheral interface controllers 34. The DMA controller may be programmable by the processors 16 to perform the DMA operations. For example, the DMA controller may be programmable via descriptors. The descriptors may be data structures stored in the memory 12A-12B that describe DMA transfers (e.g. source and destination addresses, size, etc.). Alternatively, the DMA controller may be programmable via registers in the DMA controller (not shown).

The peripherals 32A-32C may include any desired input/output devices or other hardware devices that are included on the integrated circuit 10. For example, the peripherals 32A-32C may include networking peripherals such as one or more networking media access controllers (MAC) such as an Ethernet MAC or a wireless fidelity (WiFi) controller. An audio unit including various audio processing devices may be included in the peripherals 32A-32C. One or more digital signal processors may be included in the peripherals 32A-32C. The peripherals 32A-32C may include any other desired functional such as timers, an on-chip secrets memory, an encryption engine, etc., or any combination thereof.

The peripheral interface controllers 34 may include any controllers for any type of peripheral interface. For example, the peripheral interface controllers may include various interface controllers such as a universal serial bus (USB) controller, a peripheral component interconnect express (PCIe) controller, a flash memory interface, general purpose input/output (I/O) pins, etc.

The memories 12A-12B may be any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with the integrated circuit 10 in a chip-on-chip configuration, a package-on-package configuration, or a multi-chip module configuration.

The memory PHYs 42A-42B may handle the low-level physical interface to the memory 12A-12B. For example, the memory PHYs 42A-42B may be responsible for the timing of the signals, for proper clocking to synchronous DRAM memory, etc. In one embodiment, the memory PHYs 42A-42B may be configured to lock to a clock supplied within the integrated circuit 10 and may be configured to generate a clock used by the memory 12.

It is noted that other embodiments may include other combinations of components, including subsets or supersets of the components shown in FIG. 1 and/or other components. While one instance of a given component may be shown in FIG. 1, other embodiments may include one or more instances of the given component. Similarly, throughout this detailed description, one or more instances of a given component may be included even if only one is shown, and/or embodiments that include only one instance may be used even if multiple instances are shown.

It is noted that, while a memory controller having multiple ports is shown in this embodiment, other embodiments may be a single-ported memory controller coupled to, e.g., a shared bus to the various memory operation sources.

The definition of QoS levels may vary from embodiment to embodiment. For example, an embodiment of the RT QoS levels may include a real time green (RTG) QoS level as the lowest priority RT QoS level; a real time yellow (RTY) QoS level as the medium priority RT QoS level; and a real time red (RTR) QoS level as the highest priority RT QoS level. An embodiment of the NRT QoS levels may include a best effort (BEF) QoS level as the lowest priority NRT QoS level and the low latency (LLT) QoS level as the highest priority NRT QoS level.

The RTG, RTY, and RTR QoS levels may reflect relative levels of urgency from an RT source. That is, as the amount of time before data is needed by the RT source to prevent erroneous operation decreases, the QoS level assigned to each memory operation increases to indicate the higher urgency. By treating operations having higher urgency with higher priority, the memory controller 40 may return data to the RT source more quickly and may thus aid the correct operation of the RT source.

The BEF NRT QoS level may be a request to return the data as quickly as the memory controller 40 is able, once the needs of other flows of data are met. On the other hand, the LLT NRT QoS level may be a request for low latency data. NRT memory operations having the LLT QoS level may be treated more closely, in terms of priority with other memory transactions, than those having the BEF QoS level (at least in some cases). In other cases, the BEF and LLT QoS levels may be treated the same by the memory controller 40.

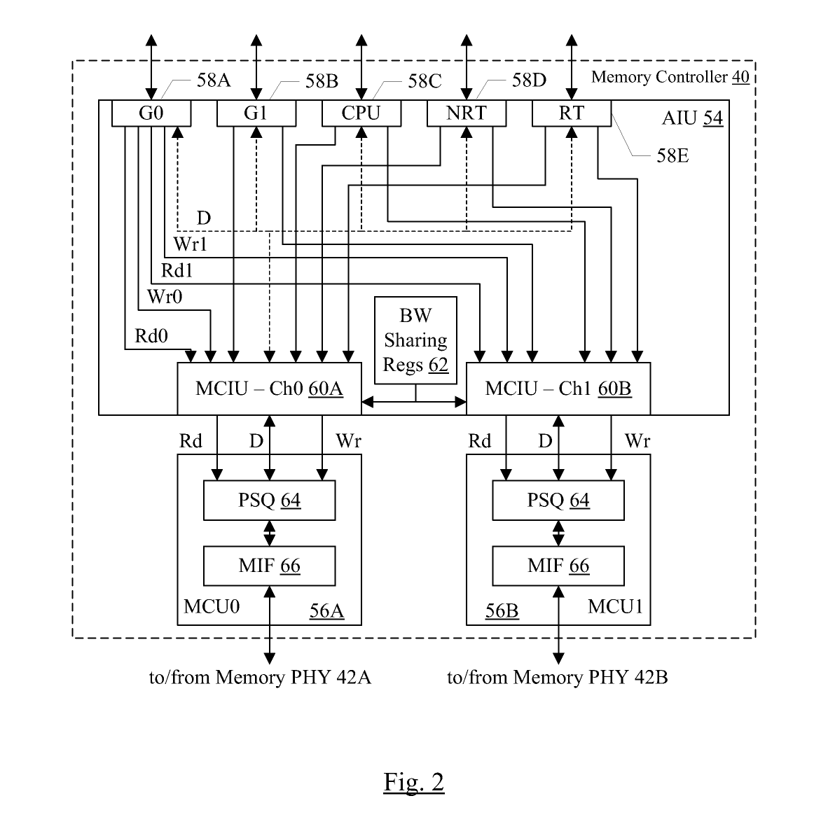

Turning next to FIG. 2, a block diagram of one embodiment of the memory controller 40 is shown. In the embodiment of FIG. 2, the memory controller 40 includes an agent interface unit (AIU) 54 and one or more memory channel units 56A-56B. There may be one memory channel unit 56A-56B for each memory channel included in a given embodiment, and other embodiments may include one channel or more than two channels. As illustrated in FIG. 2, the AIU 54 may include multiple port interface units 58A-58E. More particularly, there may be a port interface unit 58A-58E for each port 44A-44E on the memory controller 40. The AIU 54 may further include memory channel interface units (MCIUs) 60A-60B (one for each memory channel unit 56A-56B). The AIU 54 may further include one or more bandwidth sharing registers 62, which may be programmable to indicate how bandwidth is to be shared among the ports. The port interface units 58A-58E may be coupled to receive memory operations and to receive/transmit data and responses on the corresponding port, and may also be coupled to the MCIUs 60A-60B. The MCIUs 60A-60B may further be coupled to the bandwidth sharing registers 62 and to the corresponding MCU 56A-56B. As illustrated in FIG. 2, the MCUs 56A-56B may each include a presorting queue (PSQ) 64 and a memory interface circuit (MIF) 66. The PSQs 64 are coupled to the corresponding MCIUs 60A-60B and to the MIF 66 in the same MCU 56A-56B. The MIF 66 in each MCU 56A-56B is coupled to the corresponding memory PHY 42A-42B.

The AIU 54 may be configured to receive memory operations on the ports 44A-44E and to switch the memory operations to the channels addressed by those memory operations, using the QoS parameters of the memory operations as a factor in deciding which memory operations to transmit to one of the MCUs 56A-56B prior to other memory operations to the same MCU 56A-56B. Other factors may include the bandwidth sharing controls to divide bandwidth on the memory channels among the ports. The determination of which MCU 56A-56B is to receive a memory operation may depend on the address of the operation and the generation of channel selects from the address, as described in more detail below.

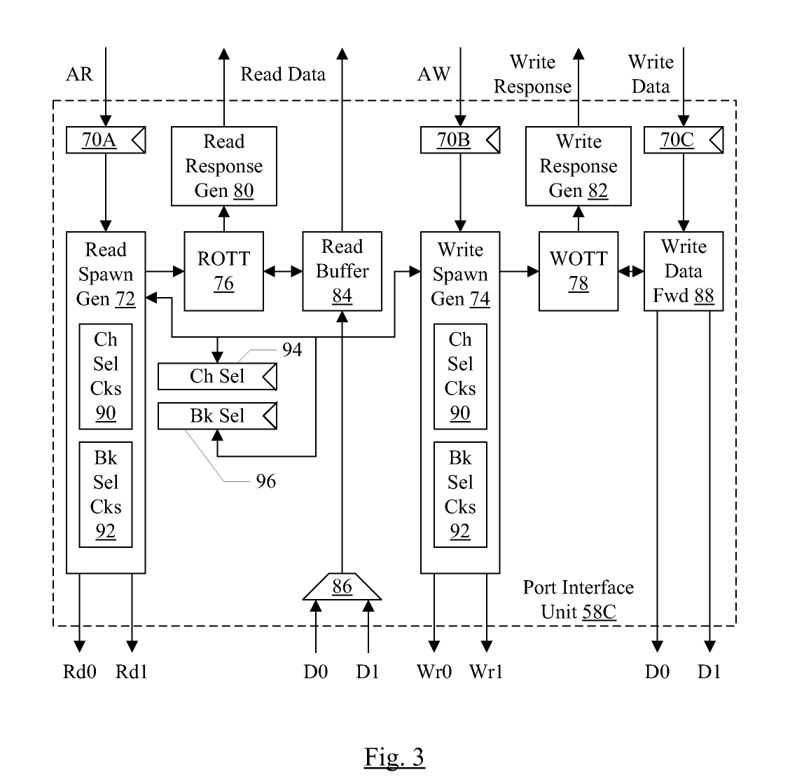

More particularly, each port interface unit 58A-58E may be configured to receive the memory operations from the corresponding port 44A-44E, and may be configured to determine the memory channel to which a given memory operation is directed. The port interface unit 58A-58E may transmit the memory operation to the corresponding MCIU 60A-60B, and may transmit reads separately from writes in the illustrated embodiment. Thus, for example, the port interface unit 58A may have a Rd0 connection and a Wr0 connection to the MCIU 60A for read operations and write operations, respectively. Similarly, the port interface unit 58A may have a Rd1 and a Wr1 connection to the MCIU 60B. The other port interface units 58B-58E may have similar connections to the MCIU 60A-60B. There may also be a data interface to transmit read data from the port interface units 58A-58B to the MCIUs 60A-60B, illustrated generally as the dotted “D” interface for the MCIU 60A in FIG. 3.

The MCIUs 60A-60B may be configured to queue the memory operations provided by the port interface units 58A-58E, and to arbitrate among the memory operations to select operations to transmit to the corresponding MCUs 56A-56B. The arbitration among operations targeted at a given memory channel may be independent of the arbitration among operations targeted at other memory channels.

The MCIUs 60A-60B may be coupled to the bandwidth sharing registers 62, which may be programmed to indicate how memory bandwidth on a channel is to be allocated to memory operations in the given channel. For example, in one embodiment, the MCIUs 60A-60B may use a deficit-weighted round-robin algorithm to select among the ports when the is no high priority traffic present (e.g. RTR or RTY QoS levels in the RT traffic). When RTR or RTY traffic is present, a round-robin mechanism may be used to select among the ports that have RTR/RTY traffic. The weights in the deficit weighted round-robin mechanism may be programmable to allocated relatively more bandwidth to one port than another. The weights may be selected to favor processor traffic over the graphics and NRT ports, for example, or to favor the graphics ports over other ports. Any set of weights may be used in various embodiments. Other embodiments may measure the bandwidth allocations in other ways. For example, percentages of the total bandwidth may be used. In other embodiments, a credit system may be used to control the relative number of operations from each port that are selected. Generally, however, operations may be selected based on both QoS parameters and on bandwidth sharing requirements in various embodiments.

The MCUs 56A-56B are configured to schedule memory operations from their queues to be transmitted on the memory channel. The MCUs may be configured to queue reads and writes separately in the PSQs 64, and may be configured to arbitrate between reads and writes using a credit based system, for example. In the credit-based system, reads and writes are allocated a certain number of credits. The number of write credits and read credits need not be equal. Each scheduled memory operation may consume a credit. Once both the write credits and the read credits are reduced to zero or less and there is a pending transaction to be scheduled, both credit may be increased by the corresponding allocated number of credits. Other embodiments may use other mechanisms to select between reads and writes. In one embodiment, the credit system may be part of the arbitration mechanism between reads and writes (along with measurements of the fullness of the write queue). That is, as the write queue becomes more full, the priority of the writes in the arbitration mechanism may increase.

In one embodiment, the QoS parameters of the write operations may be eliminated on entry into the PSQs 64. The read operations may retain the QoS parameters, and the QoS parameters may affect the read scheduling from the PSQs 64.

In an embodiment, the MCUs 56A-56B may schedule memory operations in bursts of operations (each operation in the burst consuming a credit). If the burst reduces the credit count to zero, the burst may be permitted to complete and may reduce the credit count to a negative number. When the credit counts are increased later, the negative credits may be accounted for, and thus the total number of credits after increase may be less than the allocated credit amount.

To create bursts of memory operations for scheduling, the MCUs 56A-56B may be configured to group memory operations into affinity groups. A memory operation may be said to exhibit affinity with another memory operation (or may be said to be affine to the other memory operation) if the operations may be performed efficiently on the memory interface when performed in close proximity in time. Efficiency may be measured in terms of increased bandwidth utilization. For example, SDRAM memories are characterized by a page that can be opened using an activate command (along with an address of the page). The size of the page may vary from embodiment to embodiment, and generally may refer to a number of contiguous bits that may be available for access once the activate command has been transmitted. Asynchronous DRAM memories may similarly have a page that may be opened by asserting a row address strobe control signal and by providing the row address. Two or more memory operations that access data in the same page may be affine, because only one activate/RAS may be needed on the interface for the memory operations. SDRAM memories also have independent banks and ranks A bank may be a collection of memory cells within an SDRAM chip that may have an open row (within which page hits may be detected). A rank may be selected via a chip select from the memory controller, and may include one or more SDRAM chips. Memory operations to different ranks or banks may also be affine operations, because they do not conflict and thus do not require the page to be closed and a new page to be opened. Memory operations may be viewed as affine operations only if they transfer data in the same direction (i.e. read operations may only be affine to other read operations, and similarly write operations may only be affine other write operations). Memory operations to the same page (or to an open page) may be referred to as page hits, and memory operations to different banks/ranks may be referred to as bank hits and rank hits, respectively.

The MCUs 56A-56B may also be configured to schedule commands on the memory interface to the memories 12A-12B (through the memory PHYs 42A-42B) to perform the scheduled memory operations. More particularly, in an embodiment, the MCUs 56A-56B may be configured to presynthesize the commands for each memory operation and to enqueue the commands. The MCUs 56A-56B may be configured schedule the commands to provide efficient use of the memory bandwidth. The MIFs 66 in each MCU 56A-56B may implement the presynthesis of commands and the scheduling of the commands, in an embodiment.

### Programmable Channel/Bank Interleave

Turning now to FIG. 3, a block diagram of one embodiment of the port interface unit 58C is shown. Other port interface circuits 58A-58B and 58D-58E may be similar, although there may be differences in implementation for port interface circuits that couple to different interfaces. In the illustrated embodiment, the port interface unit 58C includes buffers 70A-70B coupled to read (AR) and write (AW) interfaces to receive read and write memory operations, respectively, as illustrated in FIG. 3. The buffers 70A-70B are coupled to a read spawn generator 72 and a write spawn generator 74, respectively, which are coupled to the Rd1/Rd1 interfaces and the Wr1/Wr1 interfaces, respectively. The read spawn generator 72 is coupled to a read outstanding transaction table (ROTT) 76, and the write spawn generator 74 is coupled to a write outstanding transaction table (WOTT) 78. The ROTT 76 is coupled to a read response generator 80 which is configured to generate a read response on the interface. The ROTT is also coupled to a read buffer 84, which is coupled to receive data from either MCU 56A-56B through a mux 86 and to provide read data on the interface. The WOTT 78 is coupled to a write response generator 82 which is configured to generate a write response on the interface. The WOTT 78 is also coupled to a write data forward buffer 88, which is coupled to provide data to the MCUs 56A-56B and is coupled to receive data from a buffer 70C, which is coupled to receive write data from the interface.

The read spawn generator 72 and the write spawn generator 74 each include one or more channel select circuits 90 and one or more bank select circuits 92. The channel select circuits 90 may be configured to generate the channel selects for incoming memory operations, and the bank select circuits 92 may be configured to generate the bank selects for the incoming memory operations. The read spawn generator 72 and the write spawn generator 74 are coupled to the channel select registers 94 and the bank select registers 96 (and more particularly the channel select circuits 90 and the bank select circuits 92 may be coupled to the registers 94 and 96, respectively). Each of the registers 94 and 96 may be programmed with data that identifies which address bits are to be used to generate the channel selects and bank selects, respectively. The data may identify the address bits in any fashion For example, a bit vector may be programmed for each channel select bit and each bank select bit. The bit vector may include a bit for each address bit that is eligible to be used in the bank selection/channel selection. In one embodiment, the bytes within a cache block are all allocated to the same channel. Accordingly, the least significant address bits that define an offset with a cache block may not be eligible. For example, if a cache block is 32 bytes in size, the least significant 5 bits may not be eligible. If a cache block is 64 bytes in size, the least significant 6 bits may not be eligible, etc. In an embodiment, all other address bits are eligible. In other embodiments, some additional address bits may not be eligible. For example, some of the most significant address bits may not be eligible, or the eligible address bits may be restricted to one or more subranges of the address bits.

The channel select circuits 90 may be configured to select the address bits identified by the channel select registers 94, and may be configured to logically combine the selected address bits. In one embodiment, for example, the bit vectors from the channel select registers 94 may be bitwise-combined with the address bits to select the address bits, and the result may be exclusive ORed to produce the select. Generally, a bitwise operation may involve two operands have the same bit width, and the operation is performed on respective pairs of bits from the same bit position of each operand. In an embodiment, the bit vectors may identify selected bits with set bits in the vector, and non-selected bits with clear bits in the vector. In such a case, a bitwise AND of the bit vector and the address bits may be used. The operation performed to combine the bits may be any logical operation. For example, any hash function may be used, including exclusive OR or exclusive NOR. Exclusive OR and exclusive NOR operations may be generically referred to herein as exclusive OR type operations.

In the illustrated embodiment, both the read spawn generator 72 and the write spawn generator 74 include instances of the select circuits 90 and 92 to support concurrent receipt of a read operation and a write operation. Other embodiments may share the select circuits 90 and 92 between reads and writes (e.g. if write operations and read operations are not received concurrently on a given port). Generally, the registers 94 and 96 may each comprise one or more registers storing address bit selection data, in an embodiment. There may be one copy of the registers 94 and 96 shared by the port interface units 58A-58E, or there may be individual copies for each port interface unit 58A-58E. The memory controller 40 may be configured to ensure that the multiple copies are synchronized to the same value when updated by software.

It is noted that, while the present embodiment determines bank selection for memory operations in the agent interface unit 54 (and more particularly in the bank select circuits 92), other embodiments may generate bank selection in the memory channel interface units 60A-60B and/or the MCUs 56A-56B. In such embodiments, the bank select registers 96 and the banks select circuits 92 may be relocated to the location at which bank selection is determined.

Generally, a memory channel may refer to a physically and logically independent path to memory. A given memory device may be connected to one memory channel. A bank, on the other hand, may be a physically and logically independent section of a memory device. Operations one bank of the memory may not affect the state of another bank (e.g. which pages are open in the other bank).

For a read operation, the buffer 70A may be configured to receive the operation from the interface. The buffer 70A may be provided to capture the read operation and hold it for processing by the read spawn generator 72. In an embodiment, the buffer 70A may be a two entry “skid” buffer that permits a second operation to be captured in the event of delay for an unavailable resource to become available, for example, thus easing timing on propagating back pressure requests to the source(s) on the interface. The buffers 70B-70C may similarly be two entry skid buffers. Other embodiments may include additional entries in the skid buffers, as desired.

The read spawn generator 72 may be configured to decode the address of the read operation to determine which memory channel is addressed by the read operation (e.g. via the channel select circuits 90). The read spawn generator 72 may be configured to transmit the read operation to the addressed memory channel via the Rd0 or Rd1 interface (including the bank select determined by the bank select circuits 92). In some embodiments, a read operation may overlap memory channels. Each read operation may specify a size (i.e. a number of bytes to be read beginning at the address of the operation). If the combination of the size and the address indicates that bytes are read from more than one channel, the read spawn generator 72 may be configured to generate multiple read operations to the addressed channels. The read data from the multiple read operations may be accumulated in the read buffer 84 to be returned to the source. More particularly, in one embodiment, the read spawn generator may generate multiple read operations responsive to a read operation that reads data from more than one cache block, even if the operations are to the same channel as determined by the channel select circuits 90.

The read spawn generator 72 may also be configured to update the ROTT 76, allocating an entry in the ROTT 76 to track the progress of the read. Once the data has been received in the read buffer 84, the ROTT 76 may be configured to signal the read response generator 80 to generate a read response to transfer the data to the source. If read data is to be returned in order on the interface (e.g. according to the protocol on the interface), the data may remained buffered in the read buffer 84 until previous reads have been returned and then the ROTT 76 may signal the read response generator 80 to transfer the data. The ROTT 76 may be coupled to receive various status signals from the MCUs 56A-56B to update the status of the pending read operations (not shown in FIG. 3).

The buffer 70B, the write spawn generator 74, and the WOTT 78 may operate similarly for write operations. However, data is received rather than transmitted on the interface. The write data may be received in the write data forward buffer 88, and may be forwarded to the current location of the corresponding write operation. The WOTT 78 may signal for the write response once the write has been guaranteed to complete, terminating the writes on the interface with a write response earlier than might otherwise be possible.

It is noted that, while the embodiment illustrated in FIG. 3 includes an interface that conveys read and write memory operations separately (AR and AW, respectively), other embodiments may include a single transmission medium for both read and write operations. In such and embodiment, a single buffer 70 may receive the operations, and the read spawn generator 72 and the write spawn generator 74 may decode the command from the interface to differentiate read and write operations. Alternatively, there may be one spawn generator which generates both read and write operations and updates the ROTT 74 or the WOTT 78 accordingly.

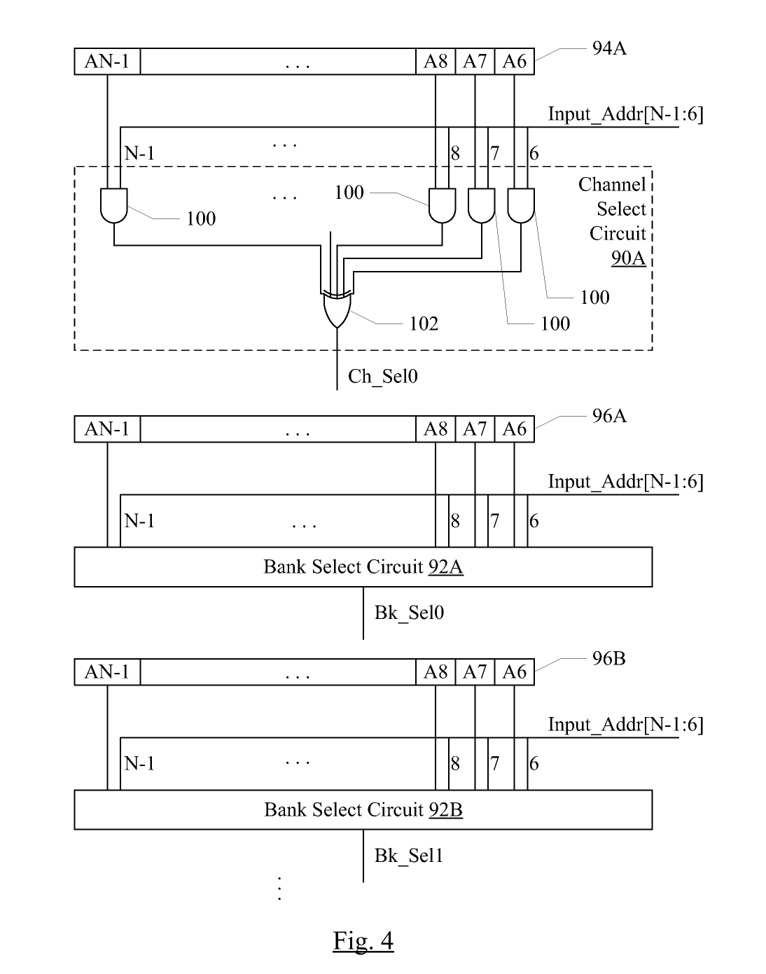

FIG. 4 is a block diagram one embodiment of channel select circuits and bank select circuits in greater detail. As illustrating in FIG. 4, a channel select circuit 90A is coupled to a channel select register 94A, bank select circuit 92A is coupled to a bank select register 96A, and a bank select circuit 92B is coupled to a bank select register 96B. Additional channel select circuits and/or bank select circuits (or fewer bank select circuits) may be used dependent on the number of channels and banks included in a given embodiment.

The channel select circuit 90A is illustrated in greater detail, and other channel select circuits and bank select circuits, such as bank select circuits 92A-92B, may be similar. Each select circuit 90A and 92A-92B may be coupled to receive a different bit vector from the corresponding registers 94A and 96A-96B. The bit vector includes a bit for each address bit (e.g. AN-1 to N6, for an address have N bits and excluding 6 least significant bits of cache block offset). Each bit of the bit vector may be provided to a respective AND gate of the bitwise AND function, along with the corresponding bit of the memory operation address (Input_Addr[N-1:6] in FIG. 4). The bitwise AND function is represented in FIG. 4 as the AND gates 100. The bitwise AND effectively masks the address bits to the selected bits. The result may then be hashed (e.g. an exclusive OR, represented by the exclusive OR gate 102 although multiple levels of XOR may be implemented) to generate the channel select bit.

The circuitry illustrated in FIG. 4 may support the embodiment of FIGS. 1 and 2, which include two channels Accordingly, one channel select bit is provided. Other embodiments may include, for example, 4 channels, in which case two channel select circuits 90 would be employed to generate two channel select bits. If more than 4 channels are included, additional channel select circuits may be provided to generate additional channel select bits. Similarly, since two bank select bits are shown in FIG. 4, each channel would include four banks. To support more than four banks, additional bank select circuits may be used.

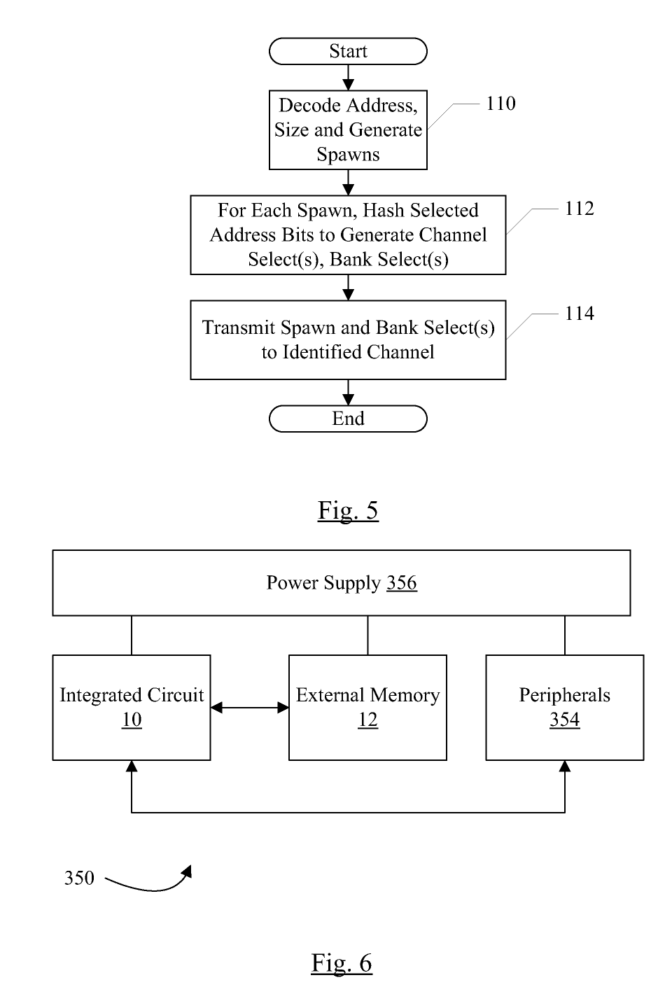

FIG. 5 is a flowchart illustrating operation of one embodiment of the memory controller 40 (and more particularly the read spawn generator 72 or write spawn generator 74, including channel select circuits 90 and bank select circuits 92) in response to receiving a memory operation is shown. While blocks are shown in a particular order for ease of understanding, other orders may be used. Blocks may be performed in parallel in combinatorial logic circuitry. Blocks, combinations of blocks, and/or the flowchart as a whole may be pipelined over multiple clock cycles.

The spawn generator 72 or 74 may be configured to decode the address and size of the memory operation and generate spawns as needed (block 110). For each spawn, the channel select circuits 90 and bank select circuits 92 may be configured to hash the selected address bits identified by the channel select registers 94 and the bank select registers 96 to generate the channel selects and bank selects for the memory operation (block 112). The spawn generator 72 or 74 may be configured to transmit each spawn and its bank selects to the identified channel (block 114).

Turning next to FIG. 6, a block diagram of one embodiment of a system 350 is shown. In the illustrated embodiment, the system 350 includes at least one instance of the integrated circuit 10 coupled to external memory 12 (e.g. the memory 12A-12B in FIG. 1). The integrated circuit 10 is coupled to one or more peripherals 354 and the external memory 12. A power supply 356 is also provided which supplies the supply voltages to the integrated circuit 10 as well as one or more supply voltages to the memory 12 and/or the peripherals 354. In some embodiments, more than one instance of the integrated circuit 10 may be included (and more than one external memory 12 may be included as well).

The peripherals 354 may include any desired circuitry, depending on the type of system 350. For example, in one embodiment, the system 350 may be a mobile device (e.g. personal digital assistant (PDA), smart phone, etc.) and the peripherals 354 may include devices for various types of wireless communication, such as wifi, Bluetooth, cellular, global positioning system, etc. The peripherals 354 may also include additional storage, including RAM storage, solid state storage, or disk storage. The peripherals 354 may include user interface devices such as a display screen, including touch display screens or multitouch display screens, keyboard or other input devices, microphones, speakers, etc. In other embodiments, the system 350 may be any type of computing system (e.g. desktop personal computer, laptop, workstation, net top etc.).

Numerous variations and modifications will become apparent to those skilled in the art once the above disclosure is fully appreciated. It is intended that the following claims be interpreted to embrace all such variations and modifications.

What is claimed is:

1. A memory controller comprising:
an agent interface unit coupled to receive memory operations from one or more agents; and
a plurality of memory channel units, each memory channel unit configured to communicate with memory on a respective memory channel of a plurality of memory channels;
wherein the agent interface unit is programmable to select a plurality of address bits from each memory operation to provide to a logic circuit in the agent interface unit, and wherein the logic circuit is configured to logically combine the plurality of address bits to identify a first memory channel of the plurality of memory channels is addressed by the memory operation, and wherein the agent interface unit is configured to transmit the memory operation to a first memory channel unit of the plurality of memory channel units which corresponds to the first memory channel responsive to an output of the logic circuit.

2. The memory controller as recited in claim 1 wherein the agent interface unit is further programmable to select a second plurality of address bits from each memory operation to provide to a second logic circuit, wherein the second logic circuit is configured to logically combine the second plurality of address bits to identify a first bank of a plurality of banks on the first memory channel, wherein the agent interface unit is configured to transmit an indication of the first bank to the first memory channel unit with the memory operation.

3. The memory controller as recited in claim 2 further comprising a plurality of registers programmable with a plurality of bit vectors, wherein each bit vector identifies address bits to be combined to identify the first memory channel and the first bank.

4. The memory controller as recited in claim 3 wherein a number of the plurality of channels is at least four, and wherein the plurality of bit vectors comprises a first bit vector identifying address bits for generating a first channel select bit and a second bit vector identifying address bits for generating a second channel select bit.

5. The memory controller as recited in claim 3 wherein a number of the plurality of banks is at least four, and wherein the plurality of bit vectors comprises a first bit vector identifying address bits for generating a first bank select bit and a second bit vector identifying address bits for generating a second bank select bit.

6. A memory controller comprising:
an agent interface unit coupled to receive memory operations from one or more agents; and
circuitry coupled to the agent interface unit and configured to communicate with a memory, wherein the memory comprises a plurality of banks;
wherein the agent interface unit is configured to select a plurality of address bits from each memory operation to provide to a logic circuit in the agent interface unit, and wherein the logic circuit is configured to logically combine the plurality of address bits to identify a first bank of the plurality of banks is addressed by the memory operation, and wherein the memory controller is configured to select the first bank in the memory for the memory operation responsive to an output of the logic circuit.

7. The memory controller as recited in claim 6 further comprising one or more registers programmable to select the plurality of address bits.

8. The memory controller as recited in claim 6 wherein a number of the plurality of banks is at least four, and wherein the plurality of address bits comprises a first subset logically combined by the logic circuit to generate a first bank select bit and a second subset logically combined by the logic circuit to generate a second bank select bit.

9. The memory controller as recited in claim 6 wherein the memory comprises a plurality of memory devices coupled to a plurality of channels, and wherein the agent interface unit is further configured to select a second plurality of address bits to provide to a second logic circuit that is configured to logically combine the second plurality of address bits to identify a first channel of the plurality of channels.

10. The memory controller as recited in claim 6 wherein the logic circuit is configured to perform an exclusive OR type operation on the plurality of address bits.

11. A method comprising:
selecting a plurality of address bits from a memory operation;
hashing the plurality of address bits to identify a first channel of a plurality of memory channels that is accessed by the memory operation; and
transmitting the memory operation on the first channel.

12. The method as recited in claim 11 wherein the selecting comprises bitwise logically combining a bit vector specifying the plurality of address bits with an address included in the memory operation.

13. The method as recited in claim 12 wherein the hashing is performed over a result of the bitwise logical combining.

14. The method as recited in claim 13 wherein the hashing comprises performing an exclusive OR type operation.

15. The method as recited in claim 12 wherein the bit vector comprises a set bit to identify a selected address bit and a clear bit to identify a non-selected address bit, and wherein the bitwise logical combining comprises logically ANDing the respective address bits and bit vector bits.

16. The method as recited in claim 11 further comprising:
selecting a second plurality of address bits from the memory operation;
hashing the second plurality of address bits to identify a first bank of a plurality of banks on the first channel that is accessed by the memory operation; and
transmitting an indication of the first bank with the memory operation.

17. An integrated circuit comprising:
one or more memory operation sources; and
a memory controller coupled to the one or more memory operation sources, wherein the memory controller is configured to couple to a memory over a plurality of channels, and wherein the memory controller is configured to logically combine address bits from each memory operation to identify a channel of the plurality of channels to which that memory operation is directed.

18. The integrated circuit as recited in claim 17 wherein the memory on a given channel of the plurality of channels includes a plurality of banks, and wherein the memory controller is configured to logically combine address bits from each memory operation to identify a bank of the plurality of banks to which that memory operation is directed.

19. The integrated circuit as recited in claim 17 wherein the memory controller comprises a plurality of ports, wherein each of the memory operation sources is coupled to one of the plurality of ports, and wherein the memory controller comprises a plurality of port interface units, each of the port interface units corresponding to a respective port of the plurality of ports and configured to transmit memory operations received on the respective port to the plurality of channels, wherein each of the plurality of port interface circuits includes a logic circuit configured to logically combine the address bits to identify the channel.

20. The integrated circuit as recited in claim 17 wherein the one or more memory operations sources comprise at least one processor.
